(19) United States
(12) Patent Application Publication
(10) Pub. No.: US 2013/0038512 A1
(43) Pub. Date: Feb. 14, 2013

(54) Simultaneous Reproduction of a Plurality of Images by Means of a Two-Dimensional Imaging Matrix

(71) Applicant: Johannes Sigwart, Hufingen (DE)

(72) Inventor: Johannes Sigwart, Hufingen (DE)

(73) Assignee: TRIDELITY AG, St. Georgen (DE)

(21) Appl. No.: 13/642,789

(22) PCT Filed: Apr. 20, 2011
(86) PCT No.: PCT/EP11/56376

§ 371 Date: Oct. 22, 2012

(30) Foreign Application Priority Data
Apr. 23, 2010 (DE) 102010018083.1

(51) Int. Cl. G09G 3/20

(52) U.S. Cl. 345/32; 345/55

(57) ABSTRACT

An image reproduction arrangement for simultaneous reproduction of a plurality of has a two-dimensional imaging matrix having the matrix elements arranged in rows and columns. The arrangement has an optical device designed to prevent observation of parts of the images from corresponding viewing angle ranges. The optical device defines a direction in the surface of the imaging matrix which runs parallel to edges of such areas of the imaging matrix which can be seen or cannot be seen from the viewing angle ranges. The imaging matrix represents blocks of matrix elements which are separated from one another in the row direction and column direction by other matrix elements which are not used to represent the image. The blocks each have matrix elements which follow one another in the column direction. The overall height of the matrix elements is greater than the width of the matrix elements.

The invention relates to an image reproduction system for simultaneously reproducing a plurality of images, wherein the system has a two-dimensional imaging matrix, via whose matrix elements, which are configured in rows and columns, the images are representable. The invention further relates to a method for simultaneously reproducing a plurality of images by means of such a two-dimensional imaging matrix. The invention further relates to a method for producing this type of image reproduction system. Furthermore, the invention relates to a digital image data record for simultaneously reproducing a plurality of images on a two-dimensional imaging matrix.

The invention relates in particular to the field of autostereoscopic representation of images. For example, DE 697 18 534 T2 describes an autostereoscopic display device, whereby a matrix playback disk has individually addressable playback elements which are divided into aligned rows, and columns perpendicular thereto. A lens plate extends essentially parallel to the plane of the playback disk. The lens plate has an array of oblong, parallel lens elements, so that individual images which are represented by means of the playback disk are perceivable by the left eye and right eye of the viewer. If the image for the left eye and the image for the right eye correspond to the natural viewing angles when an object or scene is observed, the viewer perceives the representation generated on the playback disk as a three-dimensional representation. According to the cited document, however, not just two images, but, rather, more than two images, for example six images, are represented on the playback disk. If the viewer changes the viewing angle at which he observes the image playback disk, he is thus able to view other images through the lens array with his right eye and left eye. The various matrix elements, i.e., the playback elements according to DE 697 18 534 T2, are each used to represent only one of the images. The longitudinal axes of the lenses define a direction in the plane of the playback disk which intersects the columns at a much smaller angle than the rows. If, for example in the column direction, the next adjacent matrix element which is used to represent the same image is sought, this next adjacent matrix element is not found exactly in the column direction, but, rather, is shifted by one column in the second following row. The alignment of the lens array is coordinated with the use of the matrix elements in such a way that the longitudinal axes of the lens elements define a direction which is situated in the plane of the playback disk and, for example, intersects the upper left corners of the next adjacent matrix elements, which are shifted with respect to one another by one column for every two rows. One advantage of this inclination of the lens longitudinal axis relative to the column direction is an improved ratio of the horizontal resolution (in the row direction) to the vertical resolution (in the column direction). If six images were represented by using in each case all matrix elements of a column for representing the same image, the resolution would be optimal in the vertical direction. However, in the horizontal direction the resolution would be only one-sixth the resolution of the image reproduction matrix. The impression received by the observer when a resolution ratio differs so greatly from 1 is undesirable. The observer would notice the different resolutions and have the impression of poor image quality in the row direction.

By shifting the next adjacent pixel by one column and two rows, the resolution in the horizontal direction is improved, and on the other hand is impaired in the vertical direction. As a result, however, the ratio of the horizontal resolution to the vertical resolution is closer to one.

A disadvantage of using the matrix elements according to DE 697 18 534 T2, however, is that matrix elements are required which are larger in the column direction than in the row direction. In standard commercial imaging matrices for representing color images, this is usually the case in so-called landscape mode, in which the row length is greater than the column length, since three matrix elements following another in the row direction typically have one matrix element of each of the three primary colors red, blue, and green. The overall width of the native matrix element is usually approximately equal to the height of the individual color matrix elements, and therefore is also equal to the height of the native matrix element. Due to this elongated configuration of the individual color elements, it is not possible to use an imaging matrix, using the method described in DE 697 18 534 T2, to represent images in portrait mode instead of in landscape mode, i.e., to rotate the imaging matrix by 90° about its surface normal and to represent the images with this rotated orientation of the matrix.

It is an object of the present invention to provide an image reproduction system of the type stated at the outset, a method for reproducing a plurality of images of the type stated at the outset, a production method for producing an image reproduction system, and an image data record, which allow simultaneous representation of images on the same imaging matrix, even when, from the viewpoint of the observer, i.e., relative to the image orientation, the matrix elements in the row direction are longer than in the column direction.

According to a basic concept of the present invention, matrix elements of the imaging matrix which follow one another in the column direction are used to represent the same image. Such successive matrix elements form a block that is composed of multiple matrix elements. Therefore, the particular image to be represented is not formed from individual matrix elements which adjoin matrix elements of other images in the row direction as well as in the column direction, but, rather, is represented by blocks of matrix elements which have multiple matrix elements which follow one another in the column direction. However, in the row direction and the column direction the blocks are separated from other blocks for representing the same image. Matrix elements which are not used for representing the same image are situated between the blocks that are used to represent the same image. These matrix elements which are not used to represent the same image are likewise preferably used in blocks for representing other images. However, these matrix elements may also be used only for representing a ground color (white or gray, for example).

In particular the following is proposed: An image reproduction system for simultaneously reproducing a plurality of images, wherein
the system has a two-dimensional imaging matrix, via whose matrix elements, which are configured in rows and columns, the images are representable,
the system has an optical device which is configured to in each case prevent observation of portions of the images, which are represented by the imaging matrix, from corresponding viewing angle ranges, so that in each case one of the images is discernible from the viewing angle ranges,
the optical device defines a direction in the area of the imaging matrix which extends parallel to edges of regions of the imaging matrix which are discernible or not discernible from the viewing angle ranges,
straight lines which extend in the direction intersect columns of the imaging matrix at a smaller angle than the rows of the imaging matrix,
the image reproduction system is configured in such a way that the imaging matrix of at least one of the images (for example, all of the images) is represented in blocks (preferably, with the exception on the edge of the matrix, solely in blocks) of matrix elements which are separated from one another in the row direction and the column direction of the imaging matrix by other matrix elements which are not used to represent this image,
the blocks each have matrix elements which follow one another in the column direction,
in the blocks, the overall height of the matrix elements which follow one another in the column direction is in each case greater than the width of the matrix elements to be defined in the row direction.

As mentioned, by preventing the observation of portions of the images represented by the imaging matrix, the optical device allows for discerning in each case one of the images from a certain viewing angle. However, this does not mean that only matrix elements which represent an image are visible from the viewing angle. Rather, at least portions of other matrix elements may also be visible from the viewing angle. Examples are explained in greater detail below.

The optical device may, for example, be the lens array (lens plate, for example) known from DE 697 18 534 T2. Alternatively, instead of lenses, prisms, for example, may be used to allow the observation of individual regions, namely, elongated regions which extend at a slight inclination relative to the column direction, only from certain viewing angles. Another preferred embodiment of the optical device is an arrangement of slits, wherein the slits extend parallel to one another in a plane, the plane extending parallel to the plane of the two-dimensional imaging matrix, and the observation of the matrix elements of the matrix being possible only through the slits. In contrast, regions which are opaque, or which at least admit much less light than through the slits, are situated between the slits. Such a slit arrangement is produced, for example, by applying a layer of opaque material to a transparent carrier plate. The layer of opaque material covers the regions between the slits. The same as for the elongated lenses, which are basically known from DE 697 18 534 T2, such a slit arrangement also defines a direction, namely, the direction of the edges of the slits or the direction of the center axes of the slits, and thus, also the edges of the visible regions of the matrix. If a straight line is considered which extends in the area of the imaging matrix in this direction, i.e., which extends parallel to the edges of the slits or to the longitudinal axes of the lenses or prisms, this straight line defines at least one section which extends parallel to an edge of a region of the imaging matrix that is discernible from a certain viewing angle, or which itself forms this edge. The exact location where the edge of a discernible area of the imaging matrix extends in the plane of the matrix depends on the viewing angle. However, for any viewing angle the edges always extend in the same direction that is defined by the optical device.

In addition, the optical device is coordinated with the individual images that are represented on the imaging matrix in such a way that in each case one of the images is discernible from the various viewing angles or viewing angle ranges. In other words, the observer views with his respective eye through each of the elongated lens elements, through each of the elongated prisms, or through each of the elongated slits, predominantly matrix elements which represent a certain image. “Predominantly” is understood to mean that through the lenses, prisms, or slits, a portion of the area of the imaging matrix is also discernible which is formed by matrix elements which are used for representing another image or which are not used for representing an image, i.e., are unused. However, the predominant portion of the area that is used to represent the given image is preferably at least 40% of the elongated strip-shaped surface that is discernible through the lens, the prism, or the particular slit. This applies in particular when the strip is observed from the best possible viewing angle within a viewing angle range from which the image may be observed. It is also preferred that for this best possible viewing angle, the proportion of the area of the given image, relative to any other visible image, is greater than 65%. This is achieved in particular when the slit width (measured in the row direction) for an arrangement of slits (which forms the optical device) is 50% of the width of a matrix element. In more general terms, the width of the strip-shaped visible regions, measured in the row direction, is 50% of the width of a matrix element. In addition, another optical device (a lens array or a system of prisms, for example) may be configured in this way. If the width of the discernible strip-shaped regions is larger, the proportion of the area of the image at the discernible surface decreases. The reason is that in the row direction, in addition to the matrix elements that are used to represent the image, matrix elements that are used to represent other images are also visible. If the width of the discernible strip-shaped regions is smaller, the light intensity of the image to be represented decreases.

As mentioned, straight lines extend in the direction of or parallel to the edges of the strip-shaped regions of the imaging matrix, which are discernible due to the optical device. The straight lines intersect the columns of the imaging matrix at a smaller angle than the rows of the imaging matrix. In other words, the straight lines, and thus also the edges of the discernible regions, extend at only a slight angle relative to the column direction. Examples and embodiments of the configuration of the blocks are explained in greater detail below. This configuration of the blocks results in the angle at which the edges of the discernible regions intersect the column direction, i.e., the columns in the plane of the imaging matrix.

A small intersection angle with respect to the column direction has the basic advantage that, compared to larger intersection angles, the various images that are represented on the imaging matrix may be separately perceived better, since for steeper progressions, i.e., smaller intersection angles, the portion of the area of the image to be observed from a certain viewing angle is larger compared to area regions which are not part of the image. On the other hand, an intersection angle that is too small is also not optimal, since in standard commercial imaging matrices (also referred to as the display or screen), regions extend between adjacent columns of matrix elements which are not usable for representing images. At certain viewing angles, for a small intersection angle these regions may form a large portion of the discernible strip-shaped regions. At these certain viewing angles, the particular image therefore has a weak contrast with respect to the background or the surroundings.

As mentioned, the individual blocks in the column direction extend over a plurality of successive matrix elements. The length of the individual blocks in the column direction is thus defined by the number of successive matrix elements in the column direction which form the block. The overall height of the block in the column direction is thus also fixed, thereby. According to the invention, this overall height is greater than the width of the matrix elements to be determined in the row direction. In this manner, even for matrix elements which are longer in the row direction than in the column direction, it is possible to represent images whose height is associated with the column direction and whose width is associated with the row direction. For standard commercial two-dimensional imaging matrices such as LCD displays, plasma displays, matrices of light-emitting diodes, in particular organic light-emitting diodes, or other standard commercial imaging matrices, this is usually the case in so-called portrait mode, in which the overall width of the display in the row direction is smaller than the overall height in the column direction. The invention thus easily allows standard commercial displays, which heretofore could be used only in landscape mode for simultaneously representing multiple images, to now also be used in portrait mode for this purpose.

There are various ways for the image reproduction system to acquire the property of discernibly representing the blocks in the manner according to the invention. On the one hand, as previously described, the optical device must be coordinated with the blocks and their distribution over the imaging matrix. One criterion for the suitability or adaptation of the optical device to the block representation has been stated above, namely, that in the strip-shaped, discernible regions, predominantly (at least with respect to individual other images) matrix elements of the blocks which are used to represent a certain image should be discernible. Criteria which apply in particular for certain embodiments are described in greater detail below. However, besides the optical device, which is suitably situated relative to the two-dimensional imaging matrix, the image reproduction system requires additional features or at least one additional feature in order to represent the blocks in the manner according to the invention. This feature may be the totality of the images which are simultaneously represented on the image reproduction system. The totality of the images is defined by the corresponding overall image data record which associates the particular blocks with the individual images. However, the totality of the images may also be defined by the overall signal by means of which the matrix elements of the imaging matrix are controlled in order to use the blocks in the manner according to the invention for representing images. Another option for such a feature is an image processing device which generates the image data record and/or the overall control signal from a plurality of images to be simultaneously represented.

In particular, the imaging matrix may be a matrix composed of color matrix elements of three primary colors, wherein the colors cyclically alternate in the column direction so that in each case, three matrix elements following one another in the column direction have one matrix element from each of the three primary colors. In particular for such a color matrix it is preferred that the number of matrix elements following one another in each block in the column direction is not divisible by three without a remainder or without fractions. Therefore, the number of matrix elements following one another in the column direction is not, for example, equal to 3, 6, 9, 12, etc. This results in blocks which do not have the same number of color matrix elements of the three primary colors. For example, there are fewer blue elements than red and green elements, or there are more green elements than red and blue elements, etc. However, for a regular configuration of color matrix elements within the imaging matrix and for a regular configuration of the blocks relative to another, the result is that the surplus or deficit of matrix elements in the individual blocks is formed by matrix elements of the respective other colors. For example, for adjacent blocks which are the next adjacent blocks in the direction defined by the optical device, in each case it is the color of the matrix element that forms the surplus or deficit which alternates. If, for example, three red elements, three blue elements, and two green elements are present, i.e., the green elements form the deficit, for the next adjacent block, for example, the deficit is formed by the red or blue elements. For the next adjacent block which follows in the same direction, the deficit is then formed by the color which has not formed the deficit in the two preceding blocks. The same applies for the surplus, i.e., when a color forms the surplus instead of the deficit.

One advantage of the number of matrix elements, following one another in the column direction, which is not divisible by three without a remainder or without fractions is that for all viewing angles at which the blocks may be observed, color distortions in representing the image are avoided by the totality of the blocks. If the total number of elements following one another in the column direction were divisible by three, at certain viewing angles a color distortion would result for each block since the individual matrix elements are not discernible over the complete area. If, for example, nine color matrix elements cyclically follow one another in the column direction, beginning with red, followed by green, followed by blue, from certain viewing angles a smaller portion of the topmost red element and a smaller portion of the area of the bottom blue element, for example, is discernible. Thus, an excessively large region of the green areas will be discernible, so that a green shift of the image occurs. Furthermore, in a regular configuration of blocks, this results in an identical color shift (green shift, for example) for all blocks in the same manner. On the other hand, if the individual blocks for representing the same image have different color surpluses or color deficits, and if in each case the topmost and bottommost color element of the blocks therefore does not have the same color for all blocks, although a color shift takes place for each block the color shift is different for the various blocks, and is therefore mutually compensated for overall. When there is a sufficient area of the matrix elements and a sufficiently large number of the matrix elements used overall for representing an image, the color shift of the individual blocks is no longer discernible.

It is further preferred that the number of matrix elements adjacent to one another in the column direction in each block is equal to 7 or more, and is preferably 8. This applies in particular when the height of the individual matrix elements in the column direction is approximately one-third the width of the matrix elements in the row direction, as is the case for square native matrix elements having three color matrix elements of the three primary colors.

As mentioned above, the orientation of the optical device, i.e., the direction that is defined by the optical device, namely, the direction of the edges of the regions that are discernible in each case from certain viewing angles, corresponds to the dimensions of the blocks and their configuration relative to one another. Regardless of how the blocks for representing the same image are shifted in the following rows in the column direction (a shift in the column direction is necessarily present, since the overall height of the particular blocks is less than the overall height of the matrix in the column direction), an overall height of the blocks of 7 or more matrix elements results in a relatively steep orientation of the edges of the discernible regions, i.e., results in small intersection angles of the edges with respect to the column direction. This in turn has the advantage that the various images that are represented on the matrix are perceivable with good separation from one another.

In particular when the height of the individual matrix elements is approximately one-third their width, the upper limit for the number of matrix elements of a block following one another in the column direction is preferably 14, particularly preferably 11. If even more successive pixels are combined into a block, the intersection angle of the edges of the discernible regions and of the column direction is too small, and, as mentioned above, this may result in interfaces between adjacent columns of the matrix elements becoming visible over an excessively large portion of the area.

As a result of the blocks, block rows may be defined whose row direction is parallel to the row direction of the matrix rows, and whose row height is equal to the overall height of the matrix elements of the particular block which are adjacent to one another in the column direction. In this case, all blocks are located in one of the block rows thus defined. There are preferably no blocks which begin in the column direction in one of the block rows and end in another block row. If the blocks also contain only matrix elements of one column of the imaging matrix (i.e., contain no matrix elements of adjacent columns), it is preferred that in the direction that is defined by the optical device (for example, the direction of an edge of a discernible region), blocks that are adjacent to one another and used for representing the same image are shifted with respect to one another by one column of the imaging matrix for every two row heights of the block rows. In other words, the next adjacent block is located two block rows lower and shifted by one column, or is located two block rows higher and likewise shifted by one column, but in the other direction. As mentioned above, together with the overall height of the blocks in the column direction this defines the progression of the edges of the discernible regions when the optical device (as preferred) is appropriately oriented. For example, the edge of a visible region or a parallel thereto intersects each of the blocks, situated one behind the other in the direction, in the upper left corner of the particular block. In particular when the width of the individual color elements is approximately one-third their height, and when the number of matrix elements following one another in the column direction in each block is at least 7 and is at most 14 (particularly preferably 11), an optimal orientation of the discernible regions is present for the shift by one column for every two block row heights.

For such a shift, it is also preferred that an uneven number of images, at least 3, preferably at least 5 images, is simultaneously represented on the imaging matrix, and that all images in each case are represented by blocks having the same shift by one column for every two block row heights. It is further preferred that blocks for representing all images are present in each of the block rows. The blocks for representing the various images follow cyclically in the row direction, for example, image 1, 3, 5, 2, 4, 1, etc.

In principle, all types of matrix displays or matrix screens are suitable as a two-dimensional imaging matrix, such as the above-mentioned types. However, the two-dimensional imaging matrix may also be a matrix for projection representation of images. For example, a liquid crystal [display] (LCD) matrix may be irradiated by projection light, so that the transmission properties of the individual matrix elements define the image to be represented.

The scope of the invention also includes a method for simultaneously reproducing a plurality of images by means of a two-dimensional imaging matrix, via whose matrix elements, which are configured in rows and columns, the images are represented, wherein in particular a method for operating the image reproduction system is involved, in one of the embodiments described in the present description. In this regard,
an optical device is used, and the images are represented by the imaging matrix in such a way that the optical device in each case prevents observation of portions of the images, which are represented by the imaging matrix, from corresponding viewing angle ranges, and that in each case one of the images is discernible from the viewing angle ranges,
the optical device defines a direction in the area of the imaging matrix which extends parallel to edges of regions of the imaging matrix which are discernible or not discernible from the viewing angle ranges,
straight lines which extend in the direction intersect columns of the imaging matrix at a smaller angle than the rows of the imaging matrix,
the images are represented by the imaging matrix in such a way that the imaging matrix represents at least one of the images in blocks of matrix elements which in the row direction and the column direction of the imaging matrix are separated from one another by other matrix elements which are not used for representing this image,
the blocks each have matrix elements which follow one another in the column direction,
in the blocks, the overall height of the matrix elements which follow one another in the column direction is in each case greater than the width of the matrix elements to be defined in the row direction.

Advantages and embodiments of the image reproduction system have been discussed above, and correspondingly apply to the method for reproducing a plurality of images. In particular, imaging matrices having color matrix elements of the three primary colors may be used, and in this case it is preferred that the number of matrix elements adjacent to one another in the column direction in each block is not divisible by three without a remainder or without fractions. It is further preferred that the number of matrix elements following one another in the column direction in each block is equal to 7 or more, and is preferably 8, and/or is less than or equal to 14 (particularly preferably 11). It is further preferred that the blocks as described above are shifted by one column for every two block row heights.

Furthermore, the scope of the present invention includes a method for producing an image reproduction system for simultaneously reproducing a plurality of images, wherein the method includes the following:
providing a two-dimensional imaging matrix, via whose matrix elements, which are configured in rows and columns, the images are representable,
providing and arranging an optical device in such a way that in each case observation of portions of the images, which are represented by the imaging matrix, from corresponding viewing angle ranges is prevented, so that in each case one of the images is discernible from the viewing angle ranges, so that the optical device defines a direction in the area of the imaging matrix which extends parallel to edges of regions of the imaging matrix which are discernible or not discernible from the viewing angle ranges, and so that straight lines which extend in the direction intersect the columns of the imaging matrix at a smaller angle than the rows of the imaging matrix,
providing a two-dimensional digital image data record or providing a processing device for processing a two-dimensional digital image data record, so that during operation of the image reproduction system, rows and columns of the two-dimensional image data record are represented by corresponding rows and columns of the imaging matrix, and so that at least one of the multiple images is represented in blocks of matrix elements which in the row direction and the column direction of the imaging matrix are separated from one another by other matrix elements which are not used for representing this image, the blocks each having matrix elements which follow one another in the column direction, and in the blocks, the overall height of the matrix elements which follow one another in the column direction in each case being greater than the width of the matrix elements to be defined in the row direction.

The advantages and embodiments of the production method as well result from the description of the image reproduction system. In particular, the digital image data record has the property, or the processing system processes the two-dimensional digital image data record, in such a way that the number of matrix elements following one another in columns in each block is not divisible by three without a remainder or without fractions. In addition, the number of matrix elements following one another in the column direction is preferably equal to 7 or more, and in particular is equal to 8, and/or is less than or equal to 14 (particularly preferably 11). Once again, it is preferred that the blocks are shifted by one column for every two block rows in the manner described above.

Lastly, the scope of the invention also includes a digital image data record for reproduction on a two-dimensional imaging matrix, via whose matrix elements, which are configured in rows and columns, the pixels of the data record, and therefore the images, are representable, wherein
the image data record data have a plurality of images which are to be simultaneously reproduced on the imaging matrix,
the pixels of each of the plurality of images are situated in blocks of pixels, which in the row direction and the column direction of the image data record, and thus, also in the representation of the imaging matrix, are separated from one another by other pixels or matrix elements which are not used for representing this image,
the blocks in each case have pixels or matrix elements which follow one another in the column direction,
in the blocks, the overall height of the pixels or matrix elements which follow one another in the column direction is in each case greater than the width of the pixels or matrix elements to be defined in the row direction.

The image data record already includes the use according to the invention of blocks having pixels, following one another in the column direction, for representing individual images. In addition, the scope of the invention includes an image process device for processing a two-dimensional digital image data record which has the properties of the above-defined digital image data record or which has the properties of one of its embodiments, discussed briefly below.

The image data record preferably defines a matrix composed of color pixels of three primary colors, the colors cyclically alternating in the column direction so that in each case three pixels following one another in the column direction have one pixel of each of the primary colors. It is further preferred that the number of pixels adjacent to one another in the column direction in each block is not divisible by three without a remainder or without fractions. The advantages thereof have been discussed above.

In addition, it is also preferred for the image data record that the number of pixels adjacent to one another in the column direction in each block is equal to 7 or more, and is preferably 8, and/or is less than or equal to 14 (particularly preferably 11).

Furthermore, it is preferred that the blocks define block rows whose row direction is parallel to the row direction of the pixel rows, and whose row height is equal to the overall height of the pixels of the particular block which follow one another in the column direction, wherein the blocks each contain only pixels of one column of the image data record, and adjacent blocks that are formed by pixels of the same image are shifted with respect to one another by one column of the imaging matrix for every two row heights of the block rows, in a direction which extends at an angle with respect to the column direction and which intersects the columns of the image data record at a smaller angle than the rows of the image data record.

Exemplary embodiments of the invention are now described with reference to the appended drawing. The individual figures of the drawing show the following:

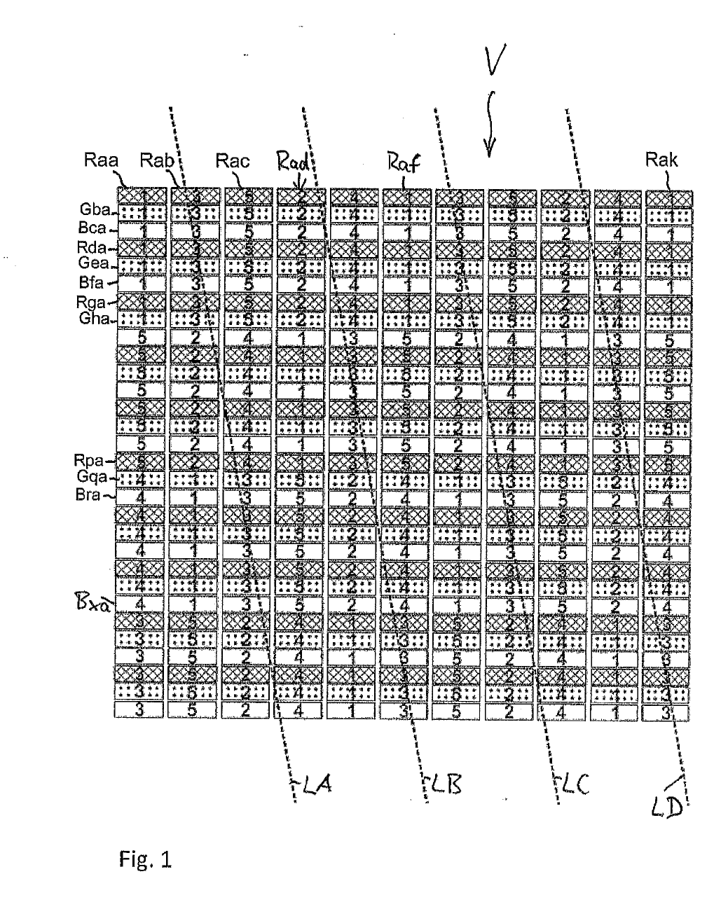

FIG. 1 shows the association of the individual matrix elements of an imaging matrix with the images which are simultaneously represented, wherein the illustration in FIG. 1 may also be interpreted as a digital image data record,

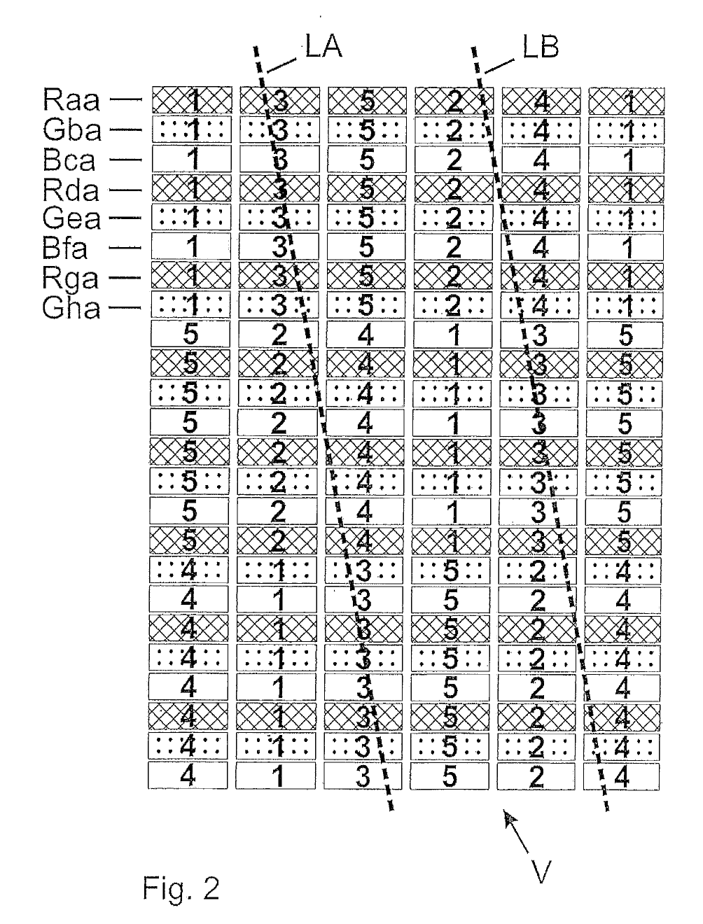

FIG. 2 shows an enlarged detail of the illustration in FIG. 1 for better clarity,

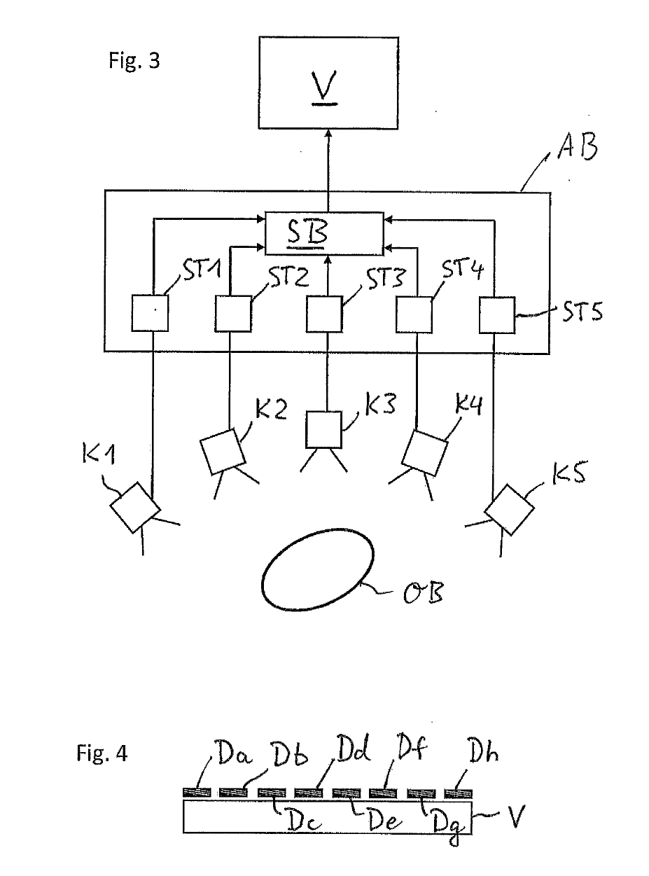

FIG. 3 shows a system for recording a plurality of images of an object from various viewing angles and for generating a corresponding digital image data record for simultaneously representing the images on an imaging matrix,

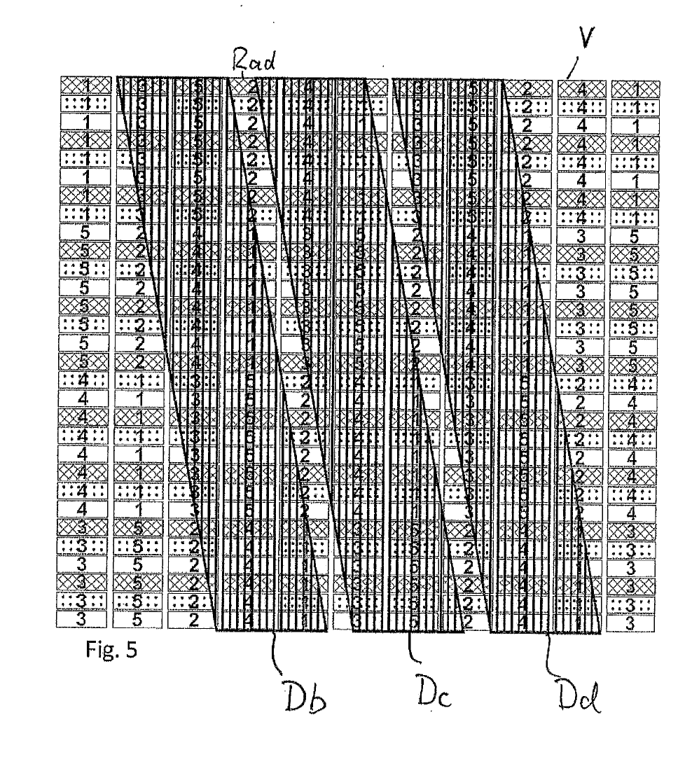

FIG. 4 schematically shows a side view of a two-dimensional imaging display, having a slit mask which, as a function of the viewing angle, in each case allows only the observation of strip-shaped regions on the matrix corresponding to the shape, size, and configuration of the slits of the slit mask relative to the matrix display,

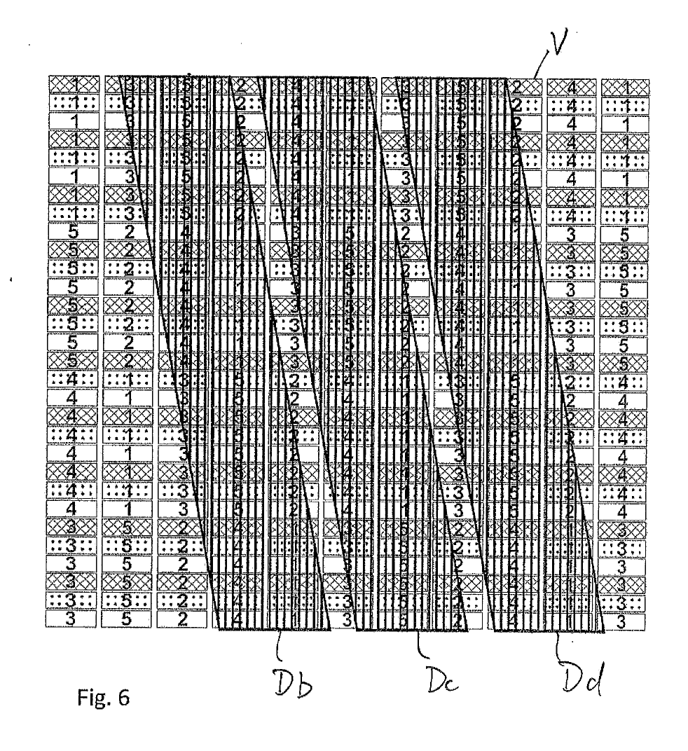

FIG. 5 shows the imaging matrix from FIG. 1, except that in the top view shown, portions of a slit arrangement located in front of the plane of the imaging matrix in the viewing direction are also discernible, and

FIG. 6 shows the system from FIG. 5 from another viewing angle, so that as a result of the slits of the slit arrangement, other strip-shaped regions in the plane of the imaging matrix are discernible.

FIG. 1 shows an imaging matrix V. This is a greatly enlarged view in which only a portion of the matrix elements, which are present in a matrix to be used in practice, are discernible. In the illustrated case, the matrix V has 11 columns and 30 rows. In practice (in landscape format), for example in the full HD format, 1920 columns of native pixels and 1080 rows of native pixels are present, i.e., a total of 3×1920 columns and 1080 rows. However, the block pattern explained with reference to FIG. 1, i.e., the grouping of individual color matrix elements in blocks that are used for representing certain images, as well as the positioning of the blocks relative to one another, may also be transferred to imaging matrices having a much larger number of matrix elements, for example full HD format, by systematic continuation of the block pattern. For example, the block pattern illustrated in FIG. 1 would be continued in such a way that a twelfth column having the same block association as the second column would follow to the right of the eleventh illustrated column, and so forth.

The matrix elements of the matrix V in FIG. 1 are color matrix elements which in each case may represent only one of the three primary colors red, green, blue. Unlike the illustration in FIG. 1, however, the color matrix elements may also cyclically follow one another in a different sequence, for example red, blue, green. The matrix element illustrated in the first row and the first column at the top left in FIG. 1 is denoted by reference character Raa. In this regard, “R” stands for “red,” since the matrix element Raa may represent a red color pixel. In the example illustrated in FIG. 1, color matrix elements for representing the same primary color are always present in the same row of matrix elements. Therefore, the color matrix element Rab to the right of the element Raa is likewise an element for representing the primary color red. The second and third letters in the designation of the matrix elements denote the row and column, respectively, in which the matrix element is present. The red matrix element in the first row and the third column is therefore denoted by reference character Rac, and the element illustrated at the top right in FIG. 1 in the first row and the eleventh column is denoted by reference character Rak. In the exemplary embodiment, elements for representing the primary color green are present in the second row of the color matrix elements, and matrix elements for representing the primary color blue are present in the third row. This sequence of the colors continues cyclically over the rows following one another in the column direction. Thus, for example, the sixth row is once again a row for representing the primary color blue. The first matrix element, i.e., in the first column of the sixth row, is therefore denoted by reference character Bfa.

The block pattern of the exemplary embodiment illustrated in FIG. 1 has blocks which in each case are composed of eight color matrix elements following one another in the column direction. The block located at the top left in FIG. 1 thus has the elements denoted by Raa, Gba, Bca, Rda, Gea, Bfa, Rga, and Gha. The next element following in the column direction is part of the next block, which is used for representing another image, and is denoted by reference character Bia. In addition, for better recognizability of the colors of the individual matrix elements, in FIG. 1 each element used for representing the primary color red is checkered, each element used for representing the primary color green is dotted, and each element used for representing the primary color blue is filled in white. In addition, each rectangular box, which represents the outer dimensions of a color matrix element, contains a numeral from 1 to 5. This numeral denotes which of the multiple images of the matrix element is used for the representation. In the exemplary embodiment, five images are simultaneously represented by the matrix V. In the block row direction, i.e., in a row composed of eight color matrix elements situated one above the other in the column direction, a block used for representing image 1 is followed to the right by a block used for representing image 3. This block is followed in the next column by a block used for representing image 5, which is followed in the next column by a block used for representing image 2, which in turn is followed in the next column by a block used for representing image 4.

In principle, the images could also be numbered differently. For example, the block to the right of the block used for representing image 1 could be denoted by the numeral 2. However, the association of the blocks, illustrated in FIG. 1, with the five different images is of importance for autostereoscopic representation of images. For example, the observer sees image 1 with his left eye and sees image 2 with his right eye from a certain relative position with respect to the imaging matrix V. The lens array, arrangement of prisms, or arrangement of slits, not illustrated in FIG. 1, has a corresponding configuration. Therefore, the images 1 and 2 are preferably generated in such a way that they contain appropriate image information for a certain three-dimensional impression on the observer. If the images are recorded by individual cameras, for example, these cameras are preferably situated in the position in which the respective eye of the observer that would directly observe the object or the scene would be present. The total of five images may preferably have been recorded or generated in some other way (by simulations, for example) so that they represent five views from different relative positions of an object or a scene. It is particularly preferred that the relative positions with respect to the object or the scene which are associated with the individual images are selected in such a way that in each case, various pairs of the images correspond to the relative position of the two eyes of an observer, so that each of the various multiple pairs generates a three-dimensional visual impression. For example, the pair of images 1, 2, the pair of images 2, 3, the pair of images 3, 4, and the pair of images 4, 5 give the observer a particularly realistic three-dimensional visual impression of a scene or an object.

As mentioned, the so-called block pattern is determined not only by the height of the blocks in the column direction, but also by the relative position of the blocks which in each case are used for the same image. In addition, the size of the blocks includes not only the extension in the column direction, but also the width of the blocks. In general it is preferred, not just with reference to the exemplary embodiment illustrated in FIG. 1, that the blocks in each case have only the width of one matrix element in the row direction. However, it would also be conceivable for a block to extend over two or more columns, for example. In this case, over the height of the block, all corresponding matrix elements in the various adjacent columns would be part of the block. In this case as well, however, the overall height of the block is greater than the width of the block in the row direction.

The block pattern illustrated in FIG. 1 has the feature that the blocks used to represent a certain image are shifted with respect to one another by one column for every two block row heights. In other words, in the direction defined by the optical device as the edge line direction of the visible regions, the next adjacent block for representing the same image is not present until the second following block row. For example, the block composed of the elements Raa-Gha has the block containing the matrix elements Gqb through Bxb as the next adjacent block in this direction. However, the second block row from the top in the illustration in FIG. 1 also contains blocks for representing the same image. Although a block for representing the first image is likewise present, for example, in column d and in the second block row (beginning with matrix element row i), and this block is located the closest distance to the block composed of the elements Raf through Ghf, these two blocks do not appear in the same strip-shaped region which the observer is able to discern when the matrix is observed by the optical device. In addition, the shift in the column direction between these two blocks is two columns. Therefore, the observer does not distinctly perceive the spatial proximity of these two blocks.

The direction defined by the optical device, which itself is not illustrated in FIG. 1, is represented by four dotted lines LA, LB, LC, and LD. For a certain viewing angle, these lines may be understood as the center axes of the strip-shaped discernible regions of the matrix. In the illustrated example, these lines LA through LD extend through the exact geometric center of the blocks for representing the third image. “Geometric center” means that the center point is located between the fourth and fifth elements of the block in the column direction, and at one-half the width of the matrix elements in the row direction.

The above-defined shift of the blocks in the direction defined by the optical device, which itself is not illustrated in FIG. 1, continues regularly over the entire matrix. Thus, starting from the block containing matrix elements Bid through Rpd, the next closest block in this direction is located in the following column e and two block rows farther down, beginning with the element Rye as the topmost of the eight elements of the block following one another in the column direction. This block is not completely illustrated in FIG. 1. The same shift by one column and two block rows also exists for the blocks for representing the other images.

FIG. 2 shows a detail from the illustration in FIG. 1. The detail contains the matrix elements illustrated at the top left in FIG. 1, namely, the first three block rows and the first six columns.

FIG. 3 schematically shows a system having five cameras K1 through K5 which record an object OB from various viewing angles and in each case generate an image or a sequence of images. The various viewing directions of two adjacent cameras K in each case preferably correspond to the various viewing directions of the right eye and left eye of an observer if he were present at the location of the camera. The digital image signals, which thus contain the image information of the object OB resolved into rows and columns, are transmitted by the respective camera K to a memory device ST1, ST2, ST3, ST4, or ST5. The memory devices ST together with an overall image data memory SB are part of a processing device AB for processing the image data, so that the image data may be represented in the manner according to the invention. Each of the image data memories ST either transmits the digital images to be represented to the overall image data memory SB unmodified, or transmits modified image data to the overall image data memory SB. If the image data are transmitted unmodified from the particular image data memory ST to the overall image data memory SB, a device which is combined with the image data memory SB modifies the image data. “Unmodified” refers to an image, for example the image that has been recorded by the camera K1, at a certain point in time. “Unmodified” does not refer to the chronological sequence of the image data. Rather, the term refers to the selection of the blocks used according to the invention for representing the particular image. By processing of the particular image, the pixels which correspond to the blocks of the imaging matrix and which are used for representing the image are selected from the original unmodified image data in the particular image matrix which are generated by the particular camera or in some other way. In the example of the block pattern according to FIG. 1 and FIG. 2, at the top left in image 1 the pixels are selected which are to be represented on the matrix elements Raa through Gha. All pixels that correspond to matrix elements for representing the other images are not selected and/or are eliminated. This may be achieved, for example, by transmitting only the selected pixels from the particular image data memory ST to the overall image data memory SB. Alternatively, the device which is combined with the overall image data memory SB may generate a new overall image matrix for representation on the imaging matrix V (for example, the matrix according to FIG. 1 and FIG. 2). The overall image contains precisely the pixels which are to be represented on the imaging matrix in order to simultaneously represent the various images. For example, the device which is combined with the overall image data memory SB may in each case retrieve from the individual image data memories ST the pixels which are to be filled corresponding to the block pattern. The generation of such an overall image is known per se. For example, the creation of such an overall image is necessary for the method described in DE 697 18 534 T2, but not by using the block pattern according to the invention. In addition, the overall image does not necessarily have to be present beforehand in an overall image data memory. Instead, the pixels which are to be represented in the blocks may be sequentially retrieved for each image directly from the associated image data memory (for example, corresponding to the image data memories ST1 through ST5). A corresponding device retrieves the pixels, which in each case are valid for a point in time and which are to be represented in the blocks of the image, from the individual image data memories, for example cyclically in the sequence of the images 1, 2, 3, 4, and 5. In this way, images which vary as a function of time may be represented in the manner of a motion picture.

FIG. 4 schematically shows a side view, i.e., a cross section, of an imaging matrix V, which may be the matrix from FIGS. 1 and 2 or FIG. 3, for example. A slit arrangement above the matrix V is apparent. Slits extend through the slit arrangement at an angle in the direction perpendicular to the image plane of FIG. 4, corresponding to the intersection angle between the edges of the strip-shaped regions which are discernible by the observer and the column direction. The column direction extends exactly perpendicularly to the image plane of FIG. 4. In contrast, the row direction extends horizontally in the image plane of FIG. 4. The regions denoted by reference characters Da, Db, Dc, Dd, De, Df, Dg, and Dh are opaque. The interspaces between these areas D are the slits.

FIG. 5 shows the imaging matrix V having the block pattern from FIG. 1, and in addition shows a portion of one exemplary embodiment of a slit arrangement. The slit arrangement involves, for example, the two slits formed by the regions Db, Dc, and Dd from FIG. 4. Additional opaque regions are present in practice, but are not illustrated in FIG. 5 for the sake of clarity. The opaque regions in FIG. 5 are not illustrated as completely opaque areas, but, rather, as bars which have crosshatched lines in the vertical direction and extend at an angle with respect to the column direction.

In the exemplary embodiment in FIG. 5, it is apparent that predominantly areas of matrix elements which form blocks for representing the second image are present in the two slits in the opaque regions D. The topmost matrix element situated in the left slit is the matrix element Rad. Also discernible in the two slits, however, are subareas of matrix elements which are not part of blocks for representing the second image. In the illustrated case, these are subareas of blocks which are used for representing the first and the third images. The proportion of the discernible areas formed by the blocks 2 with respect to the other individual discernible blocks is much greater than 50%, namely, at least 65%. This results from the selected slit width of one-half a matrix element width. In principle, however, the slit width may also be selected to be larger or smaller.

FIG. 6 shows the same opaque regions Db, Dc, and Dd in the same relative position with respect to the imaging matrix V as in FIG. 5. However, since the slits are arranged at a distance in front of the plane of the imaging matrix V in the viewing direction (also see FIG. 4), the strip-shaped region that is discernible through a slit is a function of the viewing angle of the observer. Unlike in FIG. 4, the extension of the opaque regions in the viewing direction will be much smaller in practice. For example, the opaque regions have an extension of only a few microns in the viewing direction. In contrast, the width of the slits is, for example, preferably equal to one-half the length of the matrix elements in the row direction. Compared to the situation according to FIG. 5, the position of the observer is farther to the left for the situation in FIG. 6. In relation to the situation in FIG. 5, for the situation in FIG. 6 the gaze falls more to the lower right in regions which in FIG. 5 were covered by the left edges of the opaque regions. It is assumed, as is typically the case in practice, that the distance of the observer from the plane of the imaging matrix is much greater than the distance of the opaque regions from the plane of the imaging matrix.

The exemplary embodiment for the block pattern in FIG. 1, FIG. 2, FIG. 5, and FIG. 6 contains the combination of multiple features that were described prior to the description of the figures. The block pattern has the fundamental property that the height of the blocks in the column direction is greater than their width in the row direction. In addition, the number of matrix elements following one another in the column direction is not divisible by three without remainders or fractions, and in the present example is 8. However, the number could also be 7, 10, 11, 13, or 14, for example. Furthermore, the next adjacent blocks in the direction defined by the optical device are shifted with respect to one another by two block rows and one column. Lastly, the blocks contain only matrix elements of one column. The exemplary embodiment also relates to standard commercial imaging matrices in which three color matrix elements together form a native matrix element for representing any given colors.

As a result of this combination of the features, simultaneous representation of multiple images on the imaging matrix is possible even when the width of the individual matrix elements is greater than their height in the row direction. The progression of the direction defined by the optical device, and thus, of the edges of the discernible regions, is relatively steep; i.e., the column direction intersects at a small angle of approximately 10 to 11 degrees. The proportion of the area of the matrix discernible to the observer which is formed by the image to be represented is therefore relatively large, and on the other hand, at certain viewing angles there is still no reduction in contrast due to overly high recognizability of the area situated between the columns of the matrix elements. In addition, color distortion is excluded, since, although any block considered alone is represented with color distortion, the totality of the adjacent blocks in the direction defined by the optical device compensates for the color distortion of the individual blocks.

By using this combination of features, high-quality simultaneous representations of multiple images in portrait mode are possible, in particular for standard commercial displays.

1-10. (canceled)

11. An image reproduction system for simultaneously reproducing a plurality of images, comprising:
a two-dimensional imaging matrix having color matrix elements, configured in rows and columns, the matrix elements adapted for representing images, wherein
the matrix elements are composed of three primary colors, wherein the colors cyclically alternate in a column direction so that three matrix elements following one another in the column direction have one matrix element from each of the three primary colors,
an optical device configured to prevent observation of portions of the images from corresponding viewing angle ranges, so that one of the images is discernible from the viewing angle ranges, wherein
the optical device defines a direction in the area of the imaging matrix which extends parallel to edges of regions of the imaging matrix which are discernible or not discernible from the viewing angle ranges, wherein
the image reproduction system is configured in such a way that the imaging matrix of at least one of the images is represented in blocks of matrix elements which are separated from one another in a row direction and the column direction of the imaging matrix by other matrix elements which are not used to represent the image,
the number of matrix elements following one another in the column direction in each block is not divisible by three without a remainder or without fractions, wherein
straight lines which extend in the direction defined by the optical device intersect columns of the imaging matrix at a smaller angle than the rows of the imaging matrix,
the blocks each have matrix elements which follow one another in the column direction, and wherein
the overall height of the matrix elements of the blocks which follow one another in the column direction is greater than the width of the matrix elements defined in the row direction.

12. The image reproduction system according to claim 11, wherein the number of matrix elements following one another in the column direction in each block is equal to seven or more.

13. The image reproduction system according to claim 11, wherein the blocks define block rows whose row direction is parallel to the row direction of the matrix rows, and whose row height is equal to the overall height of the matrix elements of the particular block which follow one another in the column direction, wherein the blocks in each case contain only matrix elements of one column of the imaging matrix, wherein in the direction that is defined by the optical device, blocks that are adjacent to one another and used for representing the same image are shifted with respect to one another by one column of the imaging matrix for every two row heights of the block rows.

14. A method for operating the system according to claim 11, the method comprising the steps of:
using an optical device to represent images by the imaging matrix in such a way that the optical device prevents observation of portions of the images from corresponding viewing angle ranges, and that one of the images is discernible from the viewing angle ranges,
defining a direction in the area of the imaging matrix which extends parallel to edges of regions of the imaging matrix which are discernible or not discernible from the viewing angle ranges,
representing the images by the imaging matrix in such a way that the imaging matrix represents at least one of the images in blocks of matrix elements which in a row direction and a column direction of the imaging matrix are separated from one another by other matrix elements which are not used for representing the image, wherein
the number of matrix elements following one another in the column direction in each block is not divisible by three without a remainder or without fractions, wherein
straight lines which extend in the direction intersect the columns of the imaging matrix at a smaller angle than the rows of the imaging matrix, wherein
the blocks each have matrix elements which follow one another in the column direction, and wherein
in the blocks, the overall height of the matrix elements which follow one another in the column direction is in each case greater than the width of the matrix elements defined in the row direction.

15. A method for producing an image reproduction system for simultaneously reproducing a plurality of images, wherein the method comprises the following steps:
providing a two-dimensional imaging matrix, via whose matrix elements, which are configured in rows and columns, the images are representable, wherein the imaging matrix is a matrix composed of color matrix elements of three primary colors, wherein the colors cyclically alternate in the column direction so that three matrix elements following one another in a column direction have one matrix element from each of the three primary colors,
providing and arranging an optical device in such a way that observation of portions of the images from corresponding viewing angle ranges is prevented, so that one of the images is discernible from the viewing angle ranges, so that the optical device defines a direction in the area of the imaging matrix which extends parallel to edges of regions of the imaging matrix which are discernible or not discernible from the viewing angle ranges,
providing a two-dimensional digital image data record or providing a processing device for processing a two-dimensional digital image data record, so that during operation of the image reproduction system, rows and columns of the two-dimensional image data record are represented by corresponding rows and columns of the imaging matrix, and so that at least one of the multiple images is represented in blocks of matrix elements which in the row direction and the column direction of the imaging matrix are separated from one another by other matrix elements which are not used for representing this image,
the number of matrix elements following one another in the column direction in each block is not divisible by three without a remainder or without fractions, wherein
straight lines which extend in the direction defined by the optical device intersect the columns of the imaging matrix at a smaller angle than the rows of the imaging matrix, wherein
the blocks each have matrix elements which follow one another in the column direction, and wherein
the overall height of the matrix elements of the blocks which follow one another in the column direction is greater than the width of the matrix elements to be defined in the row direction.

16. A digital image data record for reproduction on a two-dimensional imaging matrix, via whose matrix elements, which are configured in rows and columns, the pixels of the data record and the images are representable, wherein:
the image data record defines a matrix composed of color pixels of three primary colors, wherein the colors cyclically alternate in a column direction so that three pixels following one another in the colunm direction have one pixel of each of the three primary colors,
the image data record data have a plurality of images which are to be simultaneously reproduced on the imaging matrix,
the pixels of each of the plurality of images are situated in blocks of pixels, which in a row direction and the column direction of the image data record, and thus, also in
the representation of the imaging matrix, are separated from one another by other pixels or matrix elements which are not used for representing this image,
the number of matrix elements following one another in the column direction in each block is not divisible by three without a remainder or without fractions, wherein the blocks have pixels or matrix elements which follow one another in the column direction, and wherein
the overall height of the pixels or matrix elements of the blocks, which follow one another in the colunm direction is in each case greater than the width of the pixels or matrix elements to be defined in the row direction.

17. The digital image data record according to claim 16, wherein the number of pixels following one another in the column direction in each block is equal to seven or more.

18. The digital image data record according to claim 16, wherein the blocks define block rows whose row direction is parallel to the row direction of the pixel rows, and whose row height is equal to the overall height of the pixels of the particular block which follow one another in the column direction, wherein the blocks each contain only pixels of one column of the image data record, wherein adjacent blocks that are formed by pixels of the same image are shifted with respect to one another by one column of the imaging matrix for every two row heights of the block rows, in a direction which extends at an angle with respect to the column direction and which intersects the columns of the image data record at a smaller angle than the rows of the image data record.
